(19) United States
(12) Patent Application Publication
(10) Pub. No.: US 2022/0105007 A1
(43) Pub. Date: Apr. 7, 2022

(54) Single Pill Dispenser

(71) Applicant: Kristi Nixon Brown, Cedar Park, TX (US)

(72) Inventor: Kristi Nixon Brown, Cedar Park, TX (US)

(21) Appl. No.: 17/063,296

(22) Filed: Oct. 5, 2020

(51) Int. Cl. A61J 7/00; A61J 1/03; A61J 1/14

(52) U.S. Cl. CPC A61J 7/0076; A61J 1/1412; A61J 1/03

(57) ABSTRACT

A pill dispenser includes an outer Lazy Susan styled body that contains multiple single pill dispensing units within. The main body can freely rotate to allow the user to easily move to other medications as needed. The dispenser has top mounted pill bottles to allow refilling of pills. Each pill dispenser can dispense a single pill by simply pushing and releasing a spring loaded button. Each dispenser has an adjustment dial that can turned by a finger to adjust for release of different size pills. The dispenser includes a top cover to help keep the internal dispensing mechanisms free of dust and debris.

### CROSS REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### FIELD OF THE INVENTION

This invention relates generally to the field of pill dispensers, and in particular to a pill dispenser capable of dispensing of single pills by simply pressing a button.

### BACKGROUND OF THE INVENTION

There are some single pill dispensers from prior art that have tried to provide a convenient method of single pill dispensing. For example, U.S. Pat. No. 10,457,474 issued to Graziano discloses a single pill dispenser that includes a container and a cap having a pill dispensing chamber that is configured to receive a single pill. U.S. Pat. No. 9,849,069 issued to Khatri discloses a push operated single pill dispenser that dispenses a single pill at the push of a button. A third example is U.S. Pat. No. 5,791,515 issued to Khan et al that discloses a single pill dispenser that has a mechanism which allows for attachment to existing pill containers.

However, the prior art single pill dispensers all contain a major flaw that the present invention shall overcome. The main flaw inherent in all prior art single pill dispensers is that they are only used for attachment to a specific pill bottle for a specific medicine. Today many people not only take more than one medication daily, but also take supplements such as fish oil pills. Also, pills are not manufactured to just one size and there is a large range today roughly varying from a few millimeters up to 25 millimeters for supplements such as fish oil pills. Also, many people store their daily medicines in either the original pill bottles or create daily doses of several pills using rectangular storage devices.

Indeed there exists a need to provide a single pill dispenser that can dispense single pills of various sizes as well as store the various medications in a convenient and easy to use dispenser. The present invention will provide these much-needed advantages over prior art single pill dispensers.

### BRIEF SUMMARY OF THE INVENTION

It is a primary object of the present invention to provide a single pill dispenser that dispenses pills one at a time by pushing a button.

It is another object of the present invention to provide a single pill dispenser that can dispense pills of varying sizes by using a size adjustment dial.

It is a final another object of the present invention to provide a single pill dispenser that can store multiple medications using a turntable style device.

### BRIEF DESCRIPTION OF THE DRAWINGS

FIG. 1 is a perspective view of the single pill dispenser.

FIG. 2 is a top view of the single pill dispenser.

FIG. 2(a) is a sectional view of the single pill dispenser taken along line A-A of FIG. 2.

FIG. 3 is a front view of a single pill dispenser module contained within the single pill dispenser.

FIG. 4 is a top view of the single pill dispenser module.

FIG. 4(a) is a sectional view of the single pill dispenser module taken along line B-B of FIG. 4.

FIG. 5 is a perspective view of the size adjustment dial located within the single pill dispenser module.

FIG. 6 is a top view of the push button located within the single pill dispenser module.

FIG. 7 is a perspective view of the main housing of the single pill dispenser.

FIG. 8 is a perspective view of the bottom turntable assembly of the single pill dispenser.

### DETAILED DESCRIPTION OF THE INVENTION

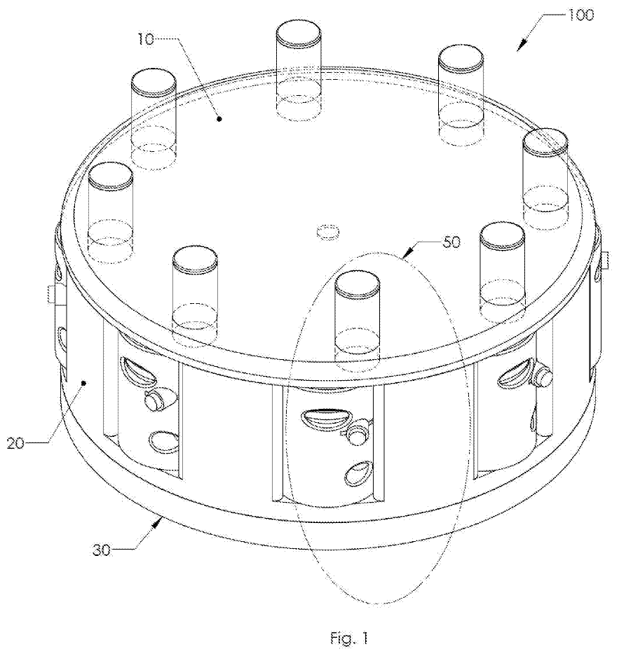

Referring now to the drawings and in particular FIG. 1, a single pill dispenser according to the present invention is generally designated by reference numeral 100. Dispenser 100 includes a top cover 10 which rests on top of the main housing body 20. The main housing body 20 is preferably a cylindrical shape and contains a plurality of single pill dispenser modules 50 that are evenly spaced in a circular arrangement. A turntable plate 30 provides a means for turning the dispenser to dispense a different medication.

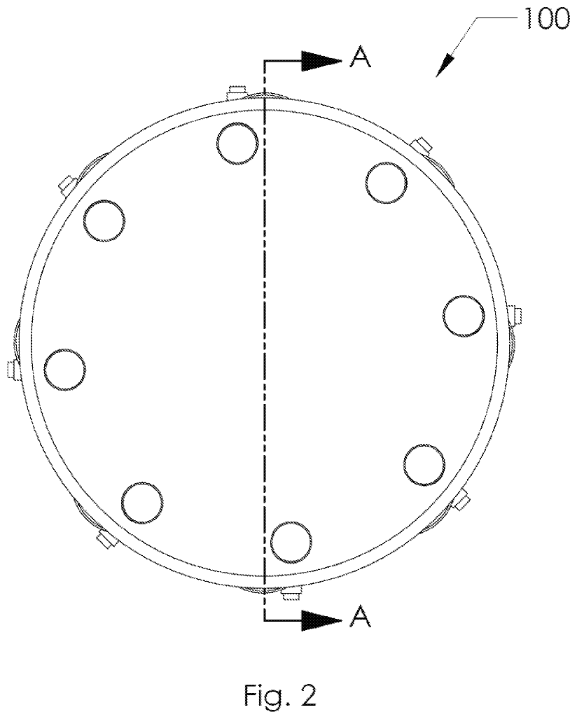

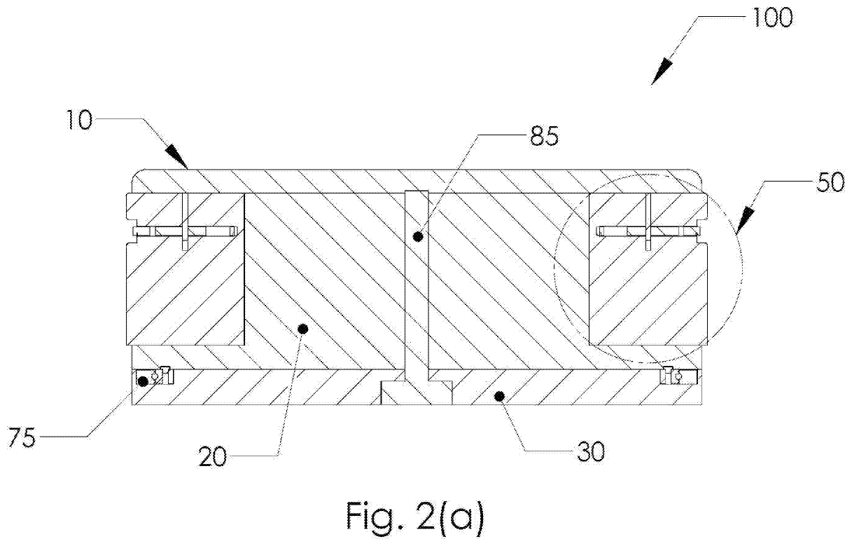

Referring next to FIG. 2, the dispenser 100 is shown in a top view with a sectional view line A-A provided for use in FIG. 2(a) to show additional internal components in cross section. The turntable plate 30 contains a center thru hole and a blind hole at the bottom surface to provide a means for attachment of a post 85. The top surface of turntable plate 30 has a blind hole to provide a means of attachment of a turntable ring 75. The ring 75 contains ball bearings inside to allow a smooth and quiet rotation of the dispenser when a new medication is selected.

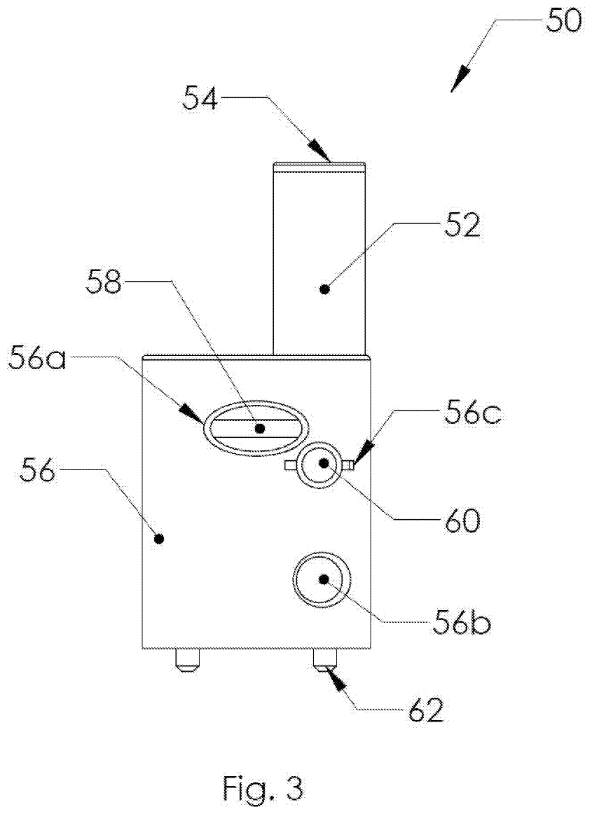

Referring next to FIG. 3, a front view of the single pill dispenser module 50 is shown. The design of the module 50 allows for various sized pills to be used. Pills are first loaded into pill bottle 52 by opening top cap 54. A housing 56 contains several components that provide a means of pill size selection and single pill dispensing. Aperture 56a provides an opening for selecting the specific pill size by rotating size adjustment dial 58. A spring-loaded push button 60 is depressed and immediately released. The internal mechanism of pill release shall be explained later in the specification. Slotted aperture 56c provides a means to contain push button 60. Exit aperture 56b provides an opening at the bottom of module 50 where single pills are dispensed at. There is a plurality of locating pins 62 at the bottom surface of housing 56 to provide a means of location during assembly into main housing 20.

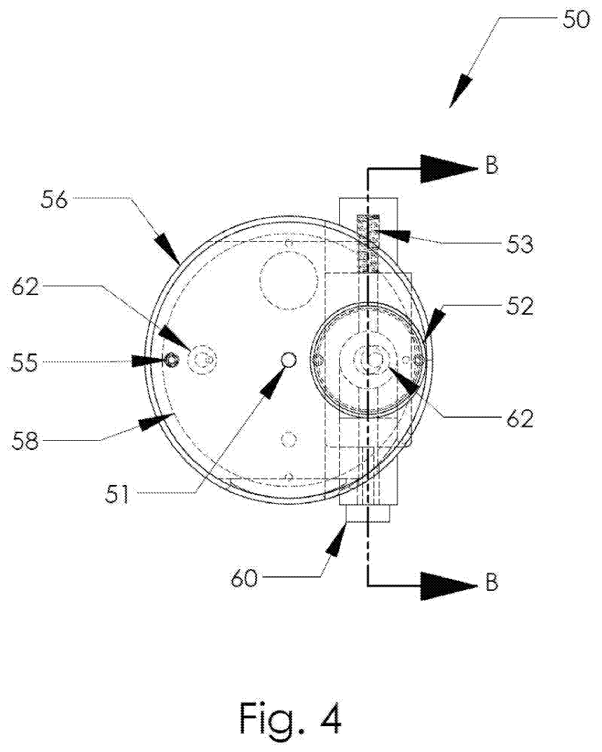

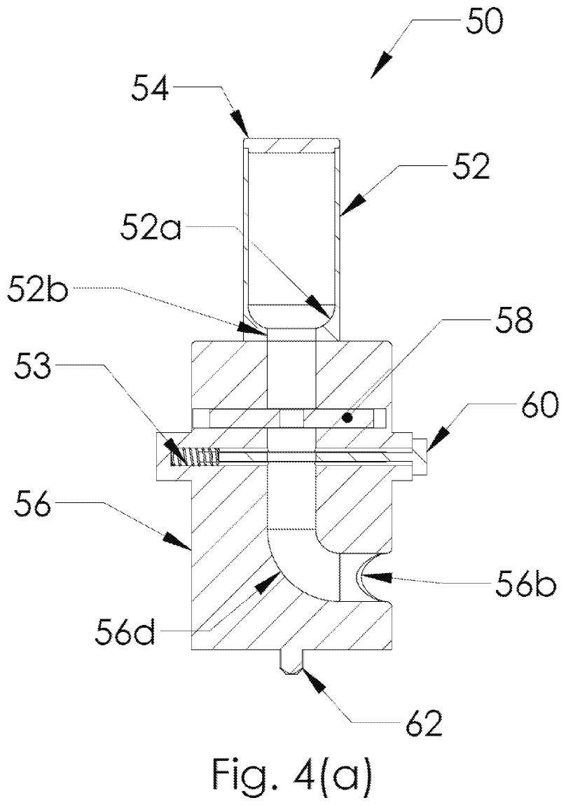

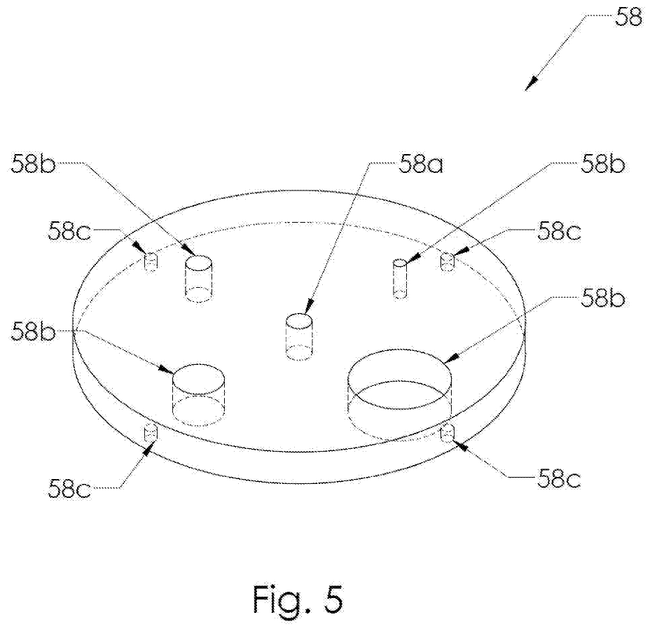

Referring next to FIGS. 4, 4(a) and 5, the dispenser module 50 is shown in top and sectional views to explain the size and single pill dispensing mechanisms. Housing 56 is generally cylindrical but contains two bosses that protrude off to one side. These bosses have internal pockets that house the spring-loaded push button mechanism which consists of a push button 60 located at the front end of module 50 and a compression spring 53 located at the rear end of module 50. The pill size adjustment dial 50 is located directly below the exit aperture 52a of bottle 52 and is also shown in detail in FIG. 5. As shown in FIG. 5, the dial 58 comprises a concentric arrangement of apertures 58b. Each aperture 58b is of a different diameter in order to allow pills of a specific size to pass through. The dial 58 is pinned at the center of housing 56 with a pin 51. A ball nose spring plunger 55 is located beneath the bottom surface of dial 58 and provides a means of fixing the location of dial 58 by frictional contact with blind holes 58c located on the bottom surface of dial 58. Holes 58c are aligned radially with apertures 58b. Pin 51 passes thru dial 58 at the center hole 58a to secure the dial yet allow rotation of the dial should the need arise to adjust the size. This might happen for example if a different sized medication is used in the same module later.

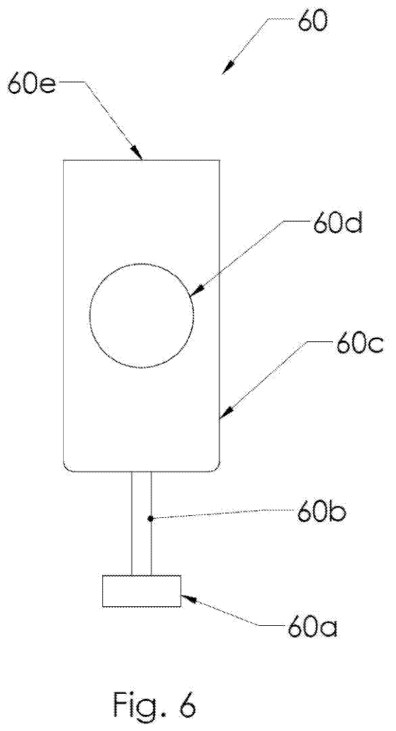

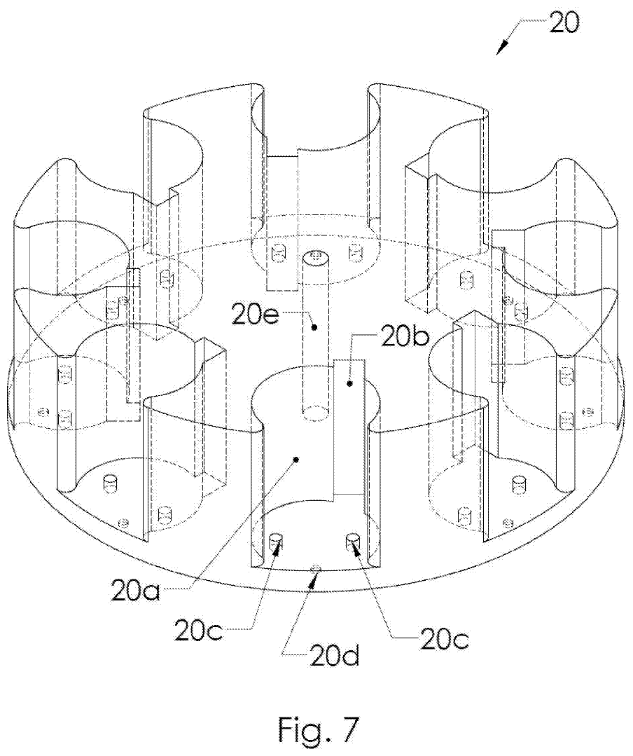

Referring now to FIGS. 4(a), 6 and 7, the single pill release mechanism shall next be explained. As shown in FIG. 4(a), the push button is shown in the depressed position to initiate release of a single pill. Pushing the button 60 will compress spring 53 until the button 60 stops against the housing 56. At this point, a pill will pass thru aperture 60d of button 60. The stiffness (or spring constant commonly called k) of spring 53 is an important design factor which will affect the return velocity of button 60. A carefully selected spring constant will provide sufficient force against the button surface 60e to shut off aperture 60d thus preventing a second pill from being dispensed. The released single pill finally travels down drop chute 56d and exits the dispenser at aperture 56b located close to the bottom of housing 56. Finally, at least two locating pins 62 are attached to main housing 20 using housing locating blind holes 20c as shown in FIG. 7.

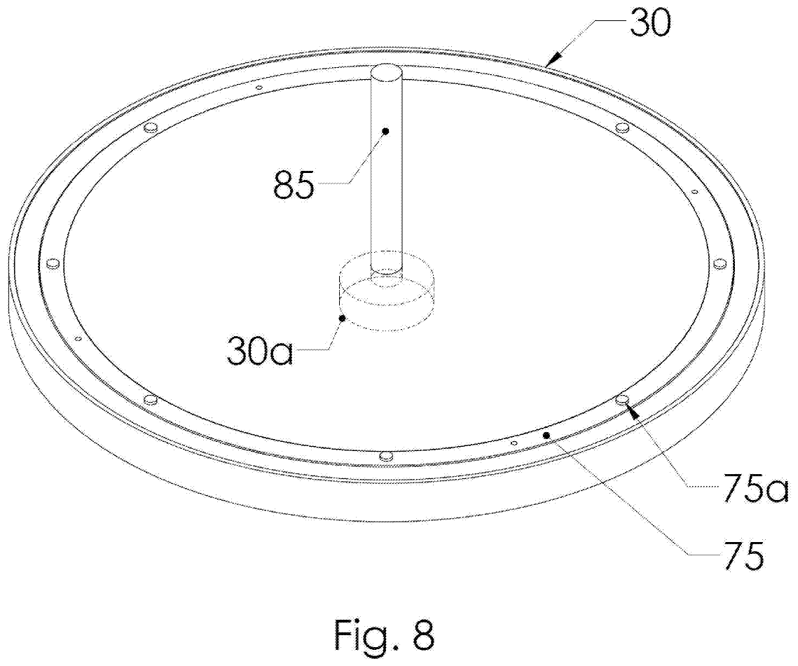

Referring finally to FIGS. 2(a), 7 and 8, the turning mechanism of dispenser 100 is explained. Turntable plate 30 contains a ball bearing style turntable ring 75 which is located just inside pf the perimeter of plate 30 at the top surface. Ring 75 contains a plurality of locating bosses 75a to provide a means of engagement to blind holes 20d located on main housing 20 (see FIG. 7). Main housing 20 includes a center thru hole 20e which allows post 85 (see FIG. 2(a)) to be slidably engaged with to allow free rotation of dispenser 100 about the axis of post 85.

What is claimed is:

1. An apparatus for dispensing pills, comprising:
a housing; said housing having a generally cylindrical shape and having a plurality of cylindrical pockets to provide a means for storage of a single pill dispensing module; said housing having a center hole to provide means for slidable attachment to a post; said housing having a plurality of blind holes at bottom surface of said pockets to provide a means for attachment to a plurality of pill dispensing modules; said housing having a plurality of blind holes at bottom surface to provide a means for mating with a turntable ring;
a top cover plate; said cover plate having a circular shape and having a plurality of thru holes; each of said thru holes to provide a means for clearance with a pill bottle; said cover plate having a center blind hole, said blind hole to provide a means for clearance with said post; a cylindrical shaped base plate; said base plate having a thru hole at the center and a blind hole at the center, said holes to provide a means for rigid attachment with said post; said base plate having a circular pocket at the top surface, said pocket to provide a means for attachment said turntable ring;
a base plate; said base plate having a circular shape and having a circular pocket at the top surface of said plate; said pocket to provide a means for housing a turntable ring; said plate having a thru hole and a counterbored hole at its center on the bottom surface of said plate; said centered holes to provide a means for rigid attachment of a post;
a turntable ring, said ring containing a plurality of ball bearings inside to provide a means of free rotation of the top portion of said ring;
a post, said post having a first base portion of a first larger diameter base and a second smaller diameter rod portion protruding upward from said first base portion; and
a pill dispenser module.

2. The pill dispenser module according to claim 1, comprising:
a pill bottle, said pill bottle having openings at both distal ends; said first opening at top distal end having a diameter that is only no less than ⅛ inch away from outer diameter of said bottle; said second opening at bottom distal end having a diameter of at least 1 inch; said bottom surface of said bottle having a plurality of cylindrical protrusions to provide a means of rigid attachment to the top surface of a pill dispenser housing;
a bottle cap having a circular shape of equivalent diameter to said pill bottle; said cap having a circular cut at its outside perimeter, said cut to provide a means of concentric alignment to said top distal end of said pill bottle;
a housing, said housing having a bored hole with a depth of approximately 60 percent of the overall height of said housing to provide a means of travel of pills from said pill bottle; said housing having a plurality of blind holes at top surface of said housing to provide a means of rigid attachment to said pill bottle; said housing having a circular aperture located near the bottom end of said housing to provide a means for pills to leave said dispenser module; said circular aperture being connected to bottom of said bored hole using a radiused circular pocket connecting both said circular aperture and said bored hole to provide a means for travel of pills during dispensing; said housing having an elliptical aperture centered at the front surface of said housing to provide a means of adjustment of a pill size dial; said housing having a first slotted aperture centered down the axis of said elliptical aperture to provide a means for containment of a pill size dial; said housing having a blind hole centered at the top surface of said housing to provide a means of rigid attachment of a pin; said housing having a second slotted aperture off to one side of said housing and located below the first slotted aperture, said second slotted aperture to provide a means for containment of a push button; said housing having a plurality of cylindrical protrusions extending from the bottom surface of said housing to provide a means for attachment of said pill dispenser module to said main dispenser housing; said housing having a blind threaded hole at the bottom surface of said first slotted aperture to provide means for rigid attachment of a ball nosed spring plunger;
a pill size dial, said dial having a circular array of circular apertures, each of said apertures having different diameters from all other apertures to provide a means of passing single pills having a size slightly smaller than said circular aperture; said dial having a center hole thru to provide a means for slidable engagement with a pin; said dial having a circular array of blind holes at bottom surface of said dial to provide a means of engagement to a ball nosed spring plunger;
a pin, said pin having its first distal end located at the top surface of said dispenser module housing; said pin having its second distal end located at the bottom of said centered blind hole of said dispenser module housing;
a push button, said button having a first portion with a cylindrical shape to provide a means for pressure to be applied to move said button; said button having a second rectangular shaped portion behind said first portion and connected to said first cylindrical portion by means of a connecting third portion with a cylindrical shape; said second rectangular portion having a centered aperture passing thru, said centered aperture being at least 1 inch in diameter; and
a ball nosed spring plunger, said spring plunger having screw threads on its outside surface for rigid attachment to said blind threaded hole of said pill module housing.
